(19) United States
(12) Patent Application Publication
(10) Pub. No.: US 2014/0333578 A1
(43) Pub. Date: Nov. 13, 2014

(54) TOUCH PANEL

(71) Applicants: Yi-Chun Wu, Hualien County (TW); Yu-Chen Liu, Taipei City (TW); Chi-Yuan Hung, New Taipei City (TW); Sheng-Cheng Wang, Taichung City (TW)

(72) Inventors: Yi-Chun Wu, Hualien County (TW); Yu-Chen Liu, Taipei City (TW); Chi-Yuan Hung, New Taipei City (TW); Sheng-Cheng Wang, Taichung City (TW)

(73) Assignee: WINTEK CORPORATION, Taichung City (TW)

(21) Appl. No.: 14/275,892

(22) Filed: May 13, 2014

(30) Foreign Application Priority Data
May 13, 2013 (TW) 102116922
May 12, 2014 (TW) 103116735

(51) Int. Cl. G06F 3/044

(52) U.S. Cl. CPC G06F 3/044
USPC 345/174

(57) ABSTRACT

A touch panel including a substrate, a plurality of first electrode series and a plurality of second electrode series is provided. The first electrode series are disposed on the substrate. Each of the first electrode series extends along a first direction and includes a plurality of first electrode pads and a plurality of bridge structures. Two adjacent first electrode pads are connected along the first direction through one of the bridge structures, where each of the bridge structures includes a conductive pattern and an optical matching pattern disposed on a surface of the conductive pattern that faces to a user so as to reduce a reflectivity of light along a viewing direction in areas where the bridge structures are disposed.

### CROSS-REFERENCE TO RELATED APPLICATION

This application claims the priority benefits of Taiwan application serial no. 102116922, filed on May 13, 2013 and Taiwan application serial no. 103116735, filed on May 12, 2014. The entirety of each of the above-mentioned patent applications is hereby incorporated by reference herein and made a part of this specification.

### BACKGROUND

1. Technical Field

The invention relates to a touch panel. Particularly, the invention relates to a touch panel capable of reducing reflectivity of bridge structures.

2. Related Art

Along with quick development and application of information technology, wireless mobile communication and information home appliance, in order to achieve purposes of easy portability, small volume and user-friendly, input devices of many information products have been changed from conventional keyboards or mice to touch panels.

Generally, the touch panels are mainly classified into resistive touch panels and capacitive touch panels. Taking the capacitive touch panel as an example, the conventional capacitive touch panel includes a substrate and a plurality of first electrode series, a plurality of second electrode series and a plurality of insulation patterns disposed on the substrate, wherein the first electrode series and the second electrode series respectively extend along different directions and are intersected to each other, and are insulated to each other through insulation patterns disposed at intersections of the first and second electrode series.

The first electrode series and the second electrode series are generally composed of a plurality of electrode pads and connection portions. Considering an application range of the touch panel (which is, for example, used in collaboration with a display panel), a material of the electrode pads is generally a transparent conductive material with good light transmittance. Moreover, since the connection portions of the first electrode series are intersected to the connection portions of the second electrode series, the connection portions of one of the first electrode series and the second electrode series are required to be fabricated by a material different to that of the electrode pads. In this way, such connecting portion is composed of a metal bridge with good conductivity, wherein the metal bridge crosses over the insulation pattern and electrically connects the electrode pads disposed at two ends of the metal bridge. However, since a reflectivity of the metal bridge is far greater than a reflectivity of the electrode pads made of the transparent conductive material in the first electrode series and the second electrode series (the reflectivity of the metal bridge is generally higher than 50%), a visual effect of the touch panel is influenced.

### SUMMARY

The invention is directed to a touch panel, which has good visual effect.

The invention provides a touch panel including a substrate, a plurality of first electrode series and a plurality of second electrode series. The first electrode series are disposed on the substrate. Each of the first electrode series extends along a first direction. Each of the first electrode series includes a plurality of first electrode pads and a plurality of bridge structures. Each of the bridge structures connects two adjacent first electrode pads in series along the first direction, where each of the bridge structures includes a conductive pattern and an optical matching pattern disposed on a surface of the conductive pattern facing to a user, so as to reduce a reflectivity of a light beam along a viewing direction in areas where the bridge structures are disposed. The second electrode series are electrically insulated to the first electrode series, and the second electrode series are disposed on the substrate, and each of the second electrode series extends along a second direction, wherein the first direction is intersected with the second direction. Each of the second electrode series includes a plurality of second electrode pads and a plurality of connection portions, and each of the connection portions connects two adjacent second electrode pads in series along the second direction.

In an embodiment of the invention, the touch panel further includes an insulation layer, and the insulation layer is disposed between the first electrode series and the second electrode series.

In an embodiment of the invention, the optical matching pattern is disposed between the conductive pattern and the substrate.

In an embodiment of the invention, a refractive index of the optical matching pattern is within a range of 1.5 to 2.5, and an extinction coefficient of the optical matching pattern is within a range of 0.5 to 2.5.

In an embodiment of the invention, a film thickness of the optical matching pattern of each of the bridge structures is greater than 100 Å and is smaller than 1000 Å.

In an embodiment of the invention, the touch panel further includes an insulation layer. The bridge structures, the first electrode pads and the second electrode pads are disposed on the substrate in a coplanar manner, and the bridge structures are disposed between the insulation layer and the substrate, and each of the connection portions are disposed on the insulation layer and crosses over the corresponding bridge structure to electrically connect two adjacent second electrode pads.

In an embodiment of the invention, the touch panel further includes an extinction layer, and the first electrode series and the second electrode series are disposed between the extinction layer and the substrate.

In an embodiment of the invention, the aforementioned touch panel further includes an insulation layer. The connection portions, the first electrode pads and the second electrode pads are disposed on the substrate in a coplanar manner, and the connection portions are disposed between the insulation layer and the substrate, such that each of the bridge structures are disposed on the insulation layer and crosses over the corresponding connection portion to electrically connect two adjacent first electrode pads.

In an embodiment of the invention, the touch panel further includes an extinction layer disposed on the substrate, and the extinction layer is disposed between the substrate and the first electrode series and between the substrate and the second electrode series.

In an embodiment of the invention, a sidewall of the conductive pattern of each of the bridge structures is aligned to a sidewall of the optical matching pattern.

In an embodiment of the invention, a sidewall of the optical matching pattern of each of the bridge structures is covered by the conductive pattern.

In an embodiment of the invention, each of the bridge structures further includes a protection pattern disposed on the conductive pattern, and the conductive pattern is disposed between the protection pattern and the optical matching pattern.

In an embodiment of the invention, the reflectivity of the light beam in an area where the bridge structure is disposed is smaller than 20%.

In an embodiment of the invention, the reflectivity of the light in an area where the bridge structure is disposed is smaller than 10%.

In an embodiment of the invention, a material of the conductive pattern of each of the bridge structures includes gold, silver, copper, aluminium, chromium, platinum, rhodium, molybdenum, titanium, nickel, indium, tin or alloys thereof, or at least one of a nitride, an oxide, an oxynitride of the above metals, or a stacked layer of at least two of the above materials.

In an embodiment of the invention, a material of the optical matching pattern of each of the bridge structures includes a material the same with that of the conductive pattern.

In an embodiment of the invention, a material of the optical matching pattern of each of the bridge structures includes a nitride, an oxide or an oxynitride of the material of the conductive pattern.

In an embodiment of the invention, a film thickness of the optical matching pattern of each of the bridge structures is smaller than 1000 Å.

In an embodiment of the invention, each of the first electrode pads is disposed between the optical matching pattern of each of the bridge structures and the substrate.

In an embodiment of the invention, a sidewall of each of the bridge structures is covered and contacted by the corresponding first electrode pads.

In an embodiment of the invention, a film thickness of the conductive pattern of each of the bridge structures is greater than 1000 Å.

In an embodiment of the invention, a light transmittance of the optical matching pattern of each of the bridge structures is greater than a light transmittance of the conductive pattern.

In an embodiment of the invention, a material of the first electrode pads and the second electrode series includes indium tin oxide, indium zinc oxide, aluminium tin oxide, aluminium zinc oxide, indium zinc germanium oxide, metal grid, or a stacked layer of at least two of the above materials.

In an embodiment of the invention, the first electrode pads and the second electrode series respectively include a metal grid layer and an optical matching layer, and the optical matching layer is disposed on a surface of the metal grid layer facing to the user.

In an embodiment of the invention, the substrate has a touch region and a peripheral region located at at least one side of the touch region, and the touch panel further includes a decoration layer, wherein the decoration layer is disposed in the peripheral region.

In an embodiment of the invention, the decoration layer is disposed on the substrate at a same side with that of the first electrode series and the second electrode series.

In an embodiment of the invention, the decoration layer is disposed on the substrate at a side opposite to that of the first electrode series and the second electrode series.

In an embodiment of the invention, the touch panel further includes a first extinction layer and a second extinction layer, wherein the first electrode series and the second electrode series are disposed between the first extinction layer and the substrate, and the second extinction layer disposes on the substrate and is disposed between the substrate and the first electrode series and between the substrate and the second electrode series.

In an embodiment of the invention, the first extinction layer is a single layer or a stacked layer of multiple layers.

In an embodiment of the invention, the second extinction layer is a single layer or a stacked layer of multiple layers.

The invention provides a touch panel including a substrate, a plurality of first electrode series, a plurality of second electrode series, a first extinction layer and a second extinction layer. The first electrode series are disposed on the substrate. Each of the first electrode series extends along a first direction, and each of the first electrode series comprises a plurality of first electrode pads and a plurality of bridge structures, and each of the bridge structures connects two adjacent first electrode pads in series along the first direction. The second electrode series are electrically insulated to the first electrode series, wherein the second electrode series is disposed on the substrate, and each of the second electrode series extends along a second direction, and the first direction is intersected with the second direction. Each of the second electrode series comprises a plurality of second electrode pads and a plurality of connection portions, and each of the connection portions connects two adjacent second electrode pads in series along the second direction. The first electrode series and the second electrode series are disposed between the first extinction layer and the substrate. The second extinction layer disposes on the substrate and is disposed between the substrate and the first electrode series and between the substrate and the second electrode series.

In an embodiment of the invention, the first extinction layer is a single layer or a stacked layer of multiple layers.

In an embodiment of the invention, the second extinction layer is a single layer or a stacked layer of multiple layers.

According to the above descriptions, in the touch panel of the invention, the conductive pattern and the optical matching pattern are used to implement the bridge structures of the electrode series, the optical matching pattern is disposed on the surface of the conductive pattern facing to the user, so as to reduce the reflectivity of the light beam along the viewing direction in areas where the bridge structures are disposed. In this way, the touch panel may have better visual effect, i.e. a contour of the bridge structures is hardly perceived by the user.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial top view of a touch panel according to a first embodiment of the invention.

FIG. 2A and FIG. 2B are respectively a cross-sectional view of FIG. 1 along a section line A-A′ and a section line B-B′.

FIG. 3A and FIG. 3B are cross-sectional views of a touch panel according to a second embodiment of the invention.

FIG. 4 is a partial top view of a touch panel according to a third embodiment of the invention.

FIG. 5A and FIG. 5B are respectively cross-sectional views of FIG. 4 along a section line C-C′ and a section line D-D′.

FIG. 6A and FIG. 6B are cross-sectional views of a touch panel according to a fourth embodiment of the invention.

FIG. 7A and FIG. 7B are cross-sectional views of a touch panel according to a fifth embodiment of the invention.

FIG. 8 is a partial top view of a touch panel according to a sixth embodiment of the invention.

### DETAILED DESCRIPTION OF DISCLOSED EMBODIMENTS

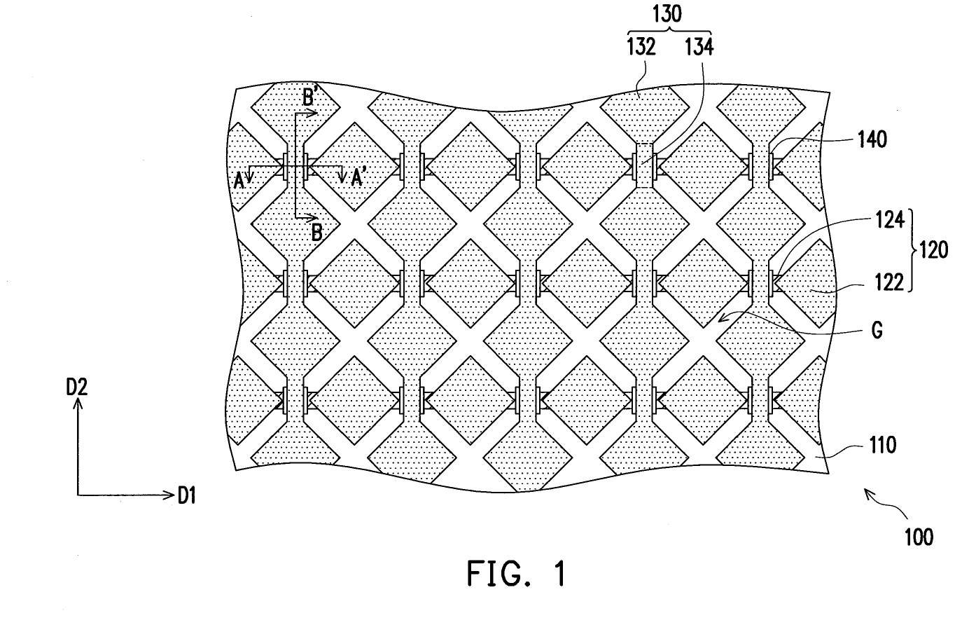

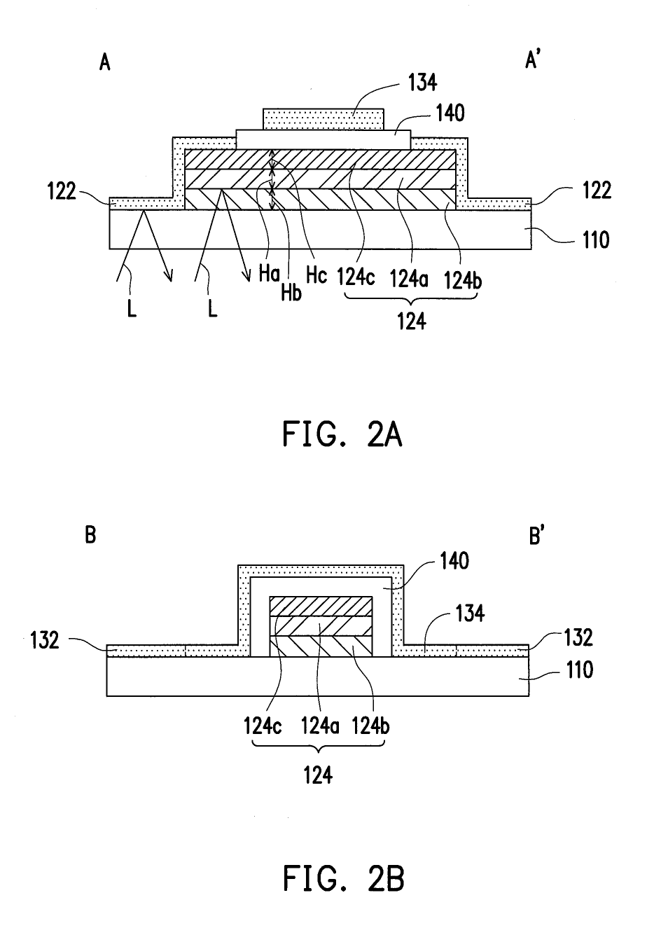

FIG. 1 is a partial top view of a touch panel according to a first embodiment of the invention. FIG. 2A and FIG. 2B are respectively a cross-sectional view of FIG. 1 along a section line A-A′ and a section line B-B′. Referring to FIG. 1, the touch panel 100 of the present embodiment includes a substrate 110, a plurality of first electrode series 120 and a plurality of second electrode series 130.

In the present embodiment, the first electrode series 120 and the second electrode series 130 are disposed on a same surface of the substrate 110, where a material of the substrate 110 can be glass, sapphire glass, polyethylene terephthalate (PET), polymethylmethacrylate (PMMA), propylene carbonate (PC), cellulose triacetate (TAC) or a substrate formed by stacking two of the above materials.

Moreover, the first electrode series 120 extend along a first direction D1 and are electrically insulated to each other. The second electrode series 130 extend along a second direction D2 and are electrically insulated to each other, wherein the first direction D1 is intersected with the second direction D2, and the first direction D1 is, for example, perpendicular to the second direction D2 in the present embodiment, though the invention is not limited thereto.

In detail, each of the first electrode series 120 includes a plurality of first electrode pads 122 and a plurality of bridge structures 124, wherein each of the bridge structures 124 connects two adjacent first electrode pads 122 in series along the first direction D1. Each of the second electrode series 130 includes a plurality of second electrode pads 132 and a plurality of connection portions 134, wherein each of the connection portions 134 connects two adjacent second electrode pads 132 in series along the second direction D2.

In the present embodiment, the touch panel 100 may further include an insulation layer 140. The insulation layer 140 is disposed between the first electrode series 120 and the second electrode series 130 to electrically insulate the first electrode series 120 and the second electrode series 130. In detail, the insulation layer 140 of the present embodiment, for example, includes a plurality of island-shaped insulation structures, and the insulation structures are disposed between the bridge structures 124 and the corresponding connection portions intersected to each other. It should be noticed that the shape of the insulation layer 140 is not limited by the invention, and in other embodiments, the insulation layer 140 may include bar-shaped insulation structures or fully covers a touch region (i.e. a region where the first electrode series 120 and the second electrode series 130 are disposed). Moreover, a material of the insulation layer 140 is, for example, an organic material or transparent photoresist, and a refractive index thereof is within a range of 1.5 to 1.9, and a thickness thereof is within a range of 1 μm to 2 μm.

Referring to FIG. 1, FIG. 2A and FIG. 2B, in the present embodiment, a sequence of forming the first electrode series 120, the second electrode series 130 and the insulation layer 140 on the substrate 110 can be as follows. The bridge structures 124 of the first electrode series 120 are first formed, and then the insulation layer 140 is formed, and finally the first electrode pads 122 of the first electrode series 120 and the second electrode series 130 are formed.

In other words, the first electrode pads 122 of the first electrode series 120 and the second electrode pads 132 and the connection portions 134 of the second electrode series 130 can be simultaneously formed and made of the same material, and the second electrode pads 132 and the connection portions 134 of the second electrode series 130 are, for example, formed integrally. For example, the material of the first electrode pad 122 and the second electrode series 130 can be a conductive metal oxide with good light transmittance such as indium tin oxide, indium zinc oxide, aluminum tin oxide, aluminum zinc oxide, indium zinc germanium oxide, etc., or a metal grid, or a stacked layer of at least two of the above materials. In the present embodiment, the material of the first electrode pads 122 and the second electrode series 130 is, for example, a conductive metal oxide with good light transmittance.

On the other hand, the bridge structures 124 of the first electrode series 120 are not simultaneously formed in collaboration with the first electrode pads 122 and the second electrode series 130, and a material of the bridge structures 124 is different to the material of the first electrode pads. For example, the material of the bridge structure can be a metal material with good conductivity.

Further, the bridge structures 124, the first electrode pads 122 and the second electrode pads 132 are disposed on the first substrate 110 in a coplanar manner, and the bridge structures 124 are disposed between the insulation layer 140 and the substrate 110, and each of the connection portions 134 are disposed on the insulation layer 140 and crosses over the corresponding bridge structure 124 to electrically connect two adjacent second electrode pads 132. Moreover, a sidewall of each of the bridge structures 124 is covered and contacted by the corresponding first electrode pads 122 (shown in FIG. 2A), and a sidewall of each of the island-shaped insulation structures (the insulation layer 140) is covered and contacted by the corresponding connection portions 134 (shown in FIG. 2B).

In the present embodiment, each of the bridge structures 124 includes a conductive pattern 124a and an optical matching pattern 124b, wherein the optical matching pattern 124b is disposed on a surface of the conductive pattern 124a facing to a user, so as to reduce a reflectivity of a light beam L along a viewing direction in areas where the bridge structures 124 are disposed. In the present embodiment, the user, for example, performs touch operations on an outer surface of the substrate 110, i.e. the outer surface (a surface opposite to the above device configuration surface) of the substrate 110 is a touch surface. Therefore, the optical matching pattern 124b of the present embodiment is, for example, disposed between the conductive pattern 124a and the substrate 110. In other embodiments, when the user performs the touch operations from the side of the device configuration surface, by configuring the conductive pattern 124a between the optical matching pattern 124b and the substrate 110 (such that the optical matching pattern 124 is disposed on the surface of the conductive pattern 124a facing to the user), so as to reduce the reflectivity of the light beam L along a viewing direction in areas where the bridge structures 124 are disposed.

Moreover, the optical matching pattern 124b and the conductive pattern 124a substantially have a same contour. In detail, a sidewall of the conductive pattern 124a of each of the bridge structure 124 is, for example, aligned with a sidewall of the optical matching pattern 124b.

In the conventional technique, a metal material is used to fabricate the bridge structure connecting two adjacent electrode pads, and such metal bridge structure is also referred to as a metal bridge. The metal bridge has a high reflectivity, so that most of the light beam is reflected at the metal bridge, which causes a poor visual effect (for example, a bright spot is viewed in the area where the metal bridge is disposed) of the touch panel. Comparatively, in the present embodiment, the optical matching pattern 124b is disposed between the conductive pattern 124a and the substrate 110, and based on matching of refractive indexes of the conductive pattern 124a and the optical matching pattern 124b, the reflectivity of the light in areas where the conductive pattern 124a is disposed can be reduced.

In detail, the conductive pattern 124a is made of metal and has a low light transmittance. The light transmittance of the optical matching pattern 124b of each of the bridge structures 124 is greater than the light transmittance of the conductive pattern 124a. Therefore, when the light beam L irradiates from the substrate 110 towards the first electrode series 120, the light beam L can passes through the optical matching pattern 124b and irradiate the conductive pattern 124a. Namely, the optical matching pattern 124b is not a component intentionally used to block the light beam L, but is a component that the light beam L is penetrable. Moreover, since the metal pattern 124a made of metal material can be regarded as a reflection surface, the light beam L can hardly pass through the conductive pattern 124a, and is blocked by the conductive pattern 124a. In this way, it is unnecessary to consider a reflection effect for the light beam L caused by a film layer disposed above the conductive pattern 124a, but only the reflectivity of the optical matching pattern 124b between the substrate 110 and the conductive pattern 124a is considered to determine the visual effect of the area where the bridge structures are disposed.

In detail, according to following reflectivity equations (including an equation 1, an equation 2 and an equation 3), a range of the refractive index and a range of the extinction coefficient of the optical matching pattern 124b can be deduced, such that when the light beam L irradiates from the substrate 110 towards the first electrode series 120, the reflectively of the light beam L in the areas where the bridge structures 124 are disposed is approximately the same to the reflectively of the light beam L in areas other than the bridge structures.

$$\begin{matrix}R = {\vert \frac{{r}_{01} + {r}_{12} \times {e}^{- 2 iβ}}{1 + {r}_{01} {r}_{12} \times {e}^{- 2 iβ}} \vert}^{2} & ( equation 1 ) \\ β = \frac{2 π}{λ} {N}_{1} {d}_{1} & ( equation 2 ) \\ {N}_{1} = {n}_{1} + {ik}_{1} & ( equation 3 )\end{matrix}$$

Where, R is reflectivity, r₀₁ is a reflection coefficient of the light beam L at a junction of the substrate 110 and the optical matching pattern 124b, r₁₂ is a reflection coefficient of the light beam L at a junction of the optical matching pattern 124b and the conductive pattern 124a, λ is a wavelength of the light beam L, d₁ is a thickness of the optical matching pattern 124b, n₁ is a refractive index of the optical matching pattern 124b, and k₁ is an extinction coefficient of the optical matching pattern 124b.

According to a simulation result, under a condition that the refractive index of the optical matching pattern 124b falls within a range of 1.5 to 2.5, and the extinction coefficient of the optical matching pattern 124b falls within a range of 0.5 to 2.5, the reflectivity of the light beam L in the areas where the bridge structures 124 are disposed can be smaller than 20%. Moreover, under the above condition, if a film thickness Hb of the optical matching pattern 124b of each of the bridge structures 124 is greater than 100 Å and is smaller than 1000 Å, the reflectivity of the light beam L in the areas where the bridge structures 124 are disposed can be further reduced to be lower than 10%. Namely, in the present embodiment, by matching the refractive index, the extinction coefficient and the thickness of the optical matching pattern 124b and the conductive pattern 124a, the reflectivity of the light beam L in the areas where the conductive patterns 124a (the bridge structures 124) are disposed can be reduced, and when the light beam L irradiates from the substrate 110 towards the first electrode series 120, the reflectively of the light beam L in the areas where the bridge structures 124 are disposed is approximately the same to the reflectively of the light beam L in areas other than the bridge structures. In this way, the touch panel 100 of the present embodiment has a better visual effect.

In the present embodiment, the conductive pattern 124a can be a single layer structure. A material of the single layer structure can be gold, silver, copper, aluminium, chromium, platinum, rhodium, molybdenum, titanium, nickel, indium, tin or alloys thereof, or at least one of a nitride, an oxide, an oxynitride of the above metals. Alternatively, the conductive pattern 124a can be a stacked layer of multiple layers, and the stacked layer can be composed of different materials, and the different materials can be the aforementioned materials of the single layer structure. On the other hand, the material of the optical matching pattern 124b of each of the bridge structures 124 can be chosen from the same materials of the above single layer structure. However, the materials of the optical matching pattern 124b and the material of the conductive pattern 124a may have different mixing ratios to achieve different refractive indexes, so as to reduce the reflectivity in the areas where the conductive pattern 124a (the bridge structures 124) are disposed by matching the refractive indexes of the optical matching pattern 124b and the conductive pattern 124a.

For example, in case that a general bridge structure is a molybdenum-aluminium-molybdenum structure or an aluminium-molybdenum structure, the reflectivity of the light beam L at the bridge structure is up to 50-90%. Comparatively, according to the design of the present embodiment, when the molybdenum layer in the molybdenum-aluminium-molybdenum structure or the aluminium-molybdenum structure that is closest to the user is changed to the optical matching pattern (for example, oxide, nitride or oxynitride of molybdenum), the reflectivity of the light beam L in the areas where the bridge structures 124 are disposed is reduced to be lower than 20%, or under the molybdenum-aluminium-molybdenum structure or the aluminium-molybdenum structure, the optical matching pattern (for example, oxide, nitride or oxynitride of molybdenum) is further disposed on the molybdenum layer closest to the user, the reflectively can be further reduced to be lower than 10%. Moreover, considering the conductivity of the conductive pattern 124a, to maintain a certain sensing sensitivity of the touch panel 100, a film thickness Ha of the conductive pattern 124a is, for example, greater than 10001, and the film thickness Hb of the optical matching pattern 124b is, for example, smaller than 10001.

Moreover, each of the bridge structures 124 of the present embodiment may further include a protection pattern 124c disposed on the conductive pattern 124a. Namely, the conductive pattern 124a is disposed between the protection pattern 124c and the optical matching pattern 124b. The protection pattern 124c can be used to protect the conductive pattern 124a and increase a structural strength of the bridge structure 124 and keep the conductive pattern 124a away from oxidization. Moreover, the protection pattern 124c can also be used to increase adhesion between the conductive pattern 124a and the insulation layer 140. Therefore, a material of the protection pattern 124c can be chosen from materials with a good adhesion effect, for example, the material of the optical matching pattern 124b. Moreover, a film thickness Hc of the protection pattern 124c is, for example, smaller than 1000 Å.

It should be noticed that the design concept of the conductive pattern 124a and the optical matching pattern 124b in the bridge structure 124 can also be applied to the first electrode pads 122 and the second electrode series 130. In detail, in other embodiments, when the material of the first electrode pads 122 and the second electrode series 130 adopts a metal grid with higher reflectivity, the first electrode pads 122 and the second electrode series 130 may further include an optical matching layer. Namely, the first electrode pads 122 and the second electrode series 130 respectively include a metal grid layer and an optical matching layer, where the optical matching layer is disposed on a surface of the metal grid layer that faces to the user. In this way, by matching the refractive index, the extinction coefficient and the thickness of the metal grid layer and the optical matching layer, the reflectivity of the light beam L along the viewing direction in the area where the metal grid layer is disposed can be reduced, and thereby a good visual effect of the touch panel may be achieved.

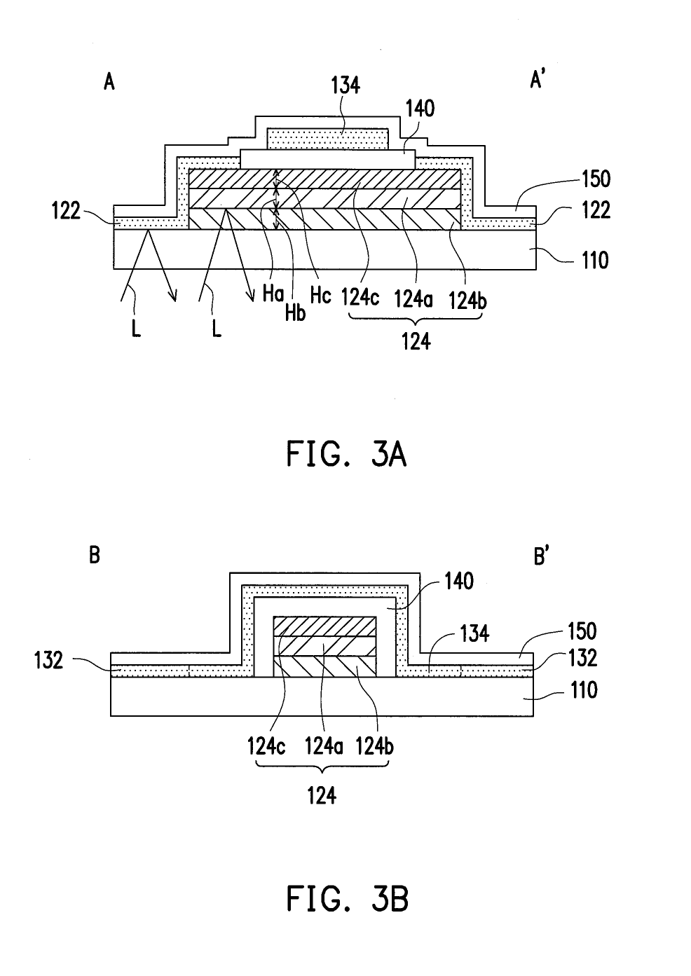

On the other hand, besides that the metal bridge may influence the visual effect of the touch panel, contours of the first electrode series 120 and the second electrode series 130 may also influence the visual effect of the touch panel. Therefore, in another embodiment, as shown in FIG. 3A and FIG. 3B, the touch panel 100 may further includes an extinction layer 150, wherein the extinction layer 150, for example, fully covers a touch region (i.e. a region where the first electrode series 120 and the second electrode series 130 are disposed) of the touch panel 100, and the first electrode series 120 and the second electrode series 130 are, for example, disposed between the extinction layer 150 and the substrate 110, though the invention is not limited thereto. In other embodiments, the extinction layer 150 may cover the substrate 110, and is disposed between the substrate 110 and the first electrode series 120 and between the substrate 110 and the second electrode series 130. Moreover, a material of the extinction layer 150 can be a general insulation material, for example, silicon oxide, silicon nitride, silicon oxynitride, silicon aluminium oxide, or a stacked layer of at least two of the above materials.

By configuring the extinction layer 150, a reflectivity difference of the light beam L between a gap G (referring to FIG. 1) between the electrode pads (including the first electrode pads 122 and the second electrode pads 132) and the electrode series (the first electrode series 120 and the second electrode series 130) can be compensated. In this way, visibility of the contours of the electrode series to human eyes can be reduced to further enhance the visual effect of the touch panel 100. Moreover, when the first electrode pads 122 and the second electrode series 130 are metal grid, for example, composed of the same material with that of the conductive pattern, the optical matching pattern can also be disposed on the first electrode pads 122 and the second electrode series 130 corresponding to the viewing direction (i.e. between the user and the first electrode pads 122 and the second electrode series 130), so as to reduce the reflectivity of the touch panel.

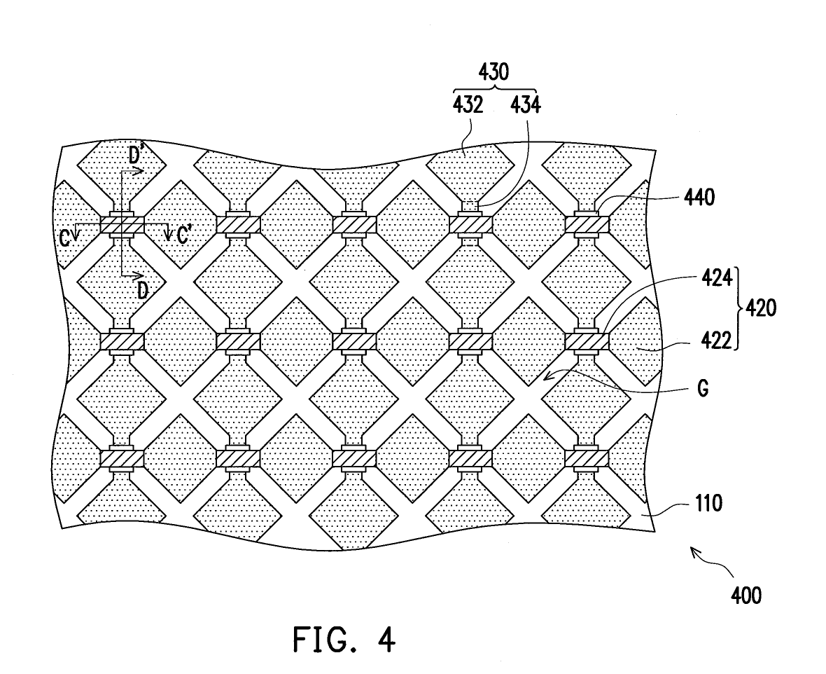

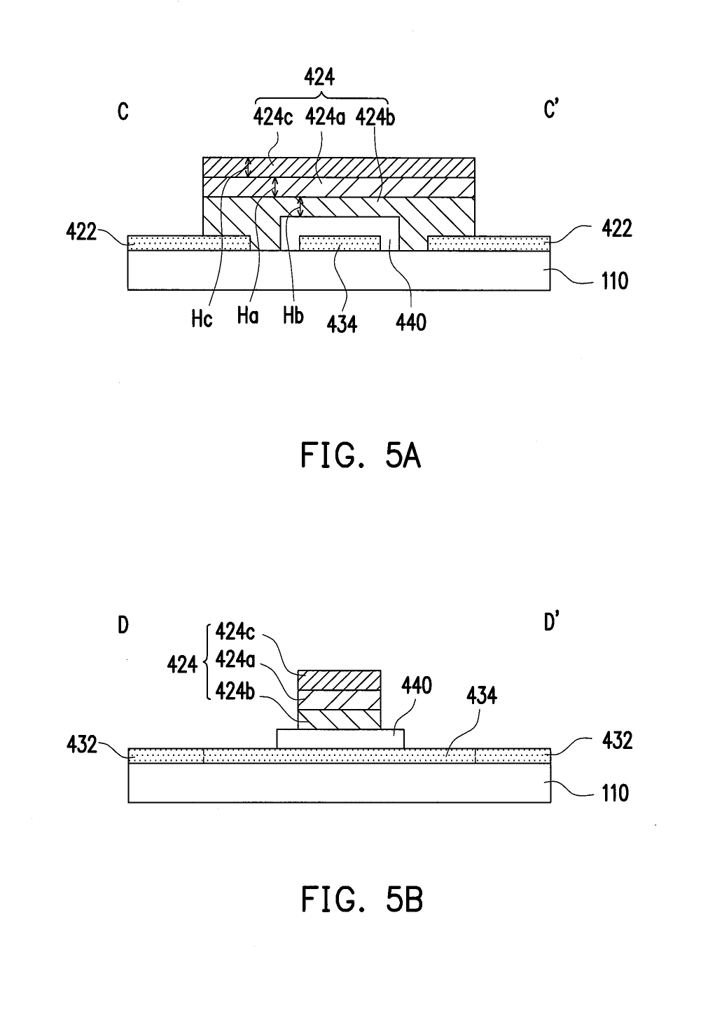

FIG. 4 is a partial top view of a touch panel according to a third embodiment of the invention. FIG. 5A and FIG. 5B are respectively cross-sectional views of FIG. 4 along a section line C-C′ and a section line D-D′. Referring to FIG. 4, FIG. 5A and FIG. 5B, the touch panel 400 of the present embodiment has similar film layers, similar materials and similar effects with that of the aforementioned touch panel 100. A main difference there between is the sequence of forming the first electrode series 420, the second electrode series 430 and the insulation layer 440 of the touch panel 400. According to the sequence, the first electrode pads 422 of the first electrode series 420 and the second electrode series 430 are first formed, and then the insulation layer 440 is formed, and finally each of the bridge structure 424 of the first electrode series 420 are formed, wherein the materials and configurations of the first electrode series 420, the second electrode series 430 and the insulation layer 440 can be referred to the materials and configurations of the first electrode series 120, the second electrode series 130 and the insulation layer 110 of the touch panel 100, which are not repeated.

Further, the connection portions 434, the first electrode pads 422 and the second electrode pads 432 are coplanar, and the connection portions 434 are disposed between the insulation layer 440 and the substrate 110, and each of the bridge structures 424 are disposed on the insulation layer 440 and crosses over the corresponding connection portion 434 to electrically connect two adjacent first electrode pads 422. Namely, a part of region of each connection portion 434 is covered by the corresponding bridge structure 424 (shown in FIG. 5B). Moreover, a part of region of each of the first electrode pads 422 is disposed between the optical matching pattern 424b of the corresponding bridge structure 424 and the substrate 110 (shown in FIG. 5A).

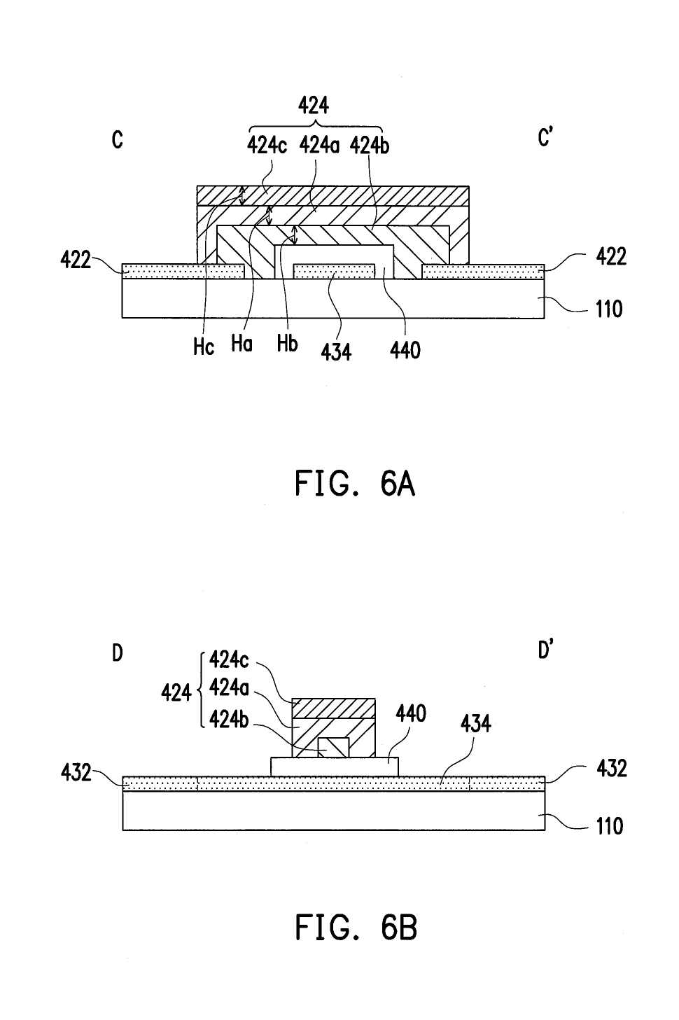

Moreover, the optical matching pattern 424b and the conductive pattern 424a of each of the bridge structures 424 substantially have the same contour. In detail, a sidewall of the conductive pattern 424a of each of the bridge structures 424 is aligned to a sidewall of the optical matching pattern 424b, though the invention is not limited thereto. In another embodiment, referring to FIG. 6A and FIG. 6B, the sidewall of the optical matching pattern 424b of each of the bridge structures 424 can be covered by the conductive pattern 424a. A difference between FIGS. 5A-5B and FIGS. 6A-6B lies in whether the optical matching pattern 424b and the conductive pattern 424a of each bridge structure 424 are simultaneously patterned, and the fabrication method of the bridge structure 424 (for example, the number of fabrication processes) is not limited by the invention.

In the embodiment of FIGS. 5A-5B and FIGS. 6A-6B, by configuring the optical matching pattern 424b, and under the design of the aforementioned parameters (the film thickness Hb of each optical matching pattern 424b is greater than 100 Å and is smaller than 1000 Å, the refractive index thereof is within the range of 1.5 to 2.5, and the extinction coefficient is within the range of 0.5 to 2.5), the reflectivity of the light beam L in the area there the bridge structures 424 are disposed can also be smaller than 20%. Namely, by matching the refractive index, the extinction coefficient and the thickness of the optical matching pattern 424b and the conductive pattern 424a, the reflectivity of the light beam L in the areas where the conductive patterns 424a (the bridge structures 424) are disposed can be reduced, and when the light beam L irradiates from the substrate 110 towards the first electrode series 420, the reflectively of the light beam L in the areas where the bridge structures 424 are disposed is greatly reduced. In this way, the touch panel 400 of the present embodiment has a better visual effect.

Moreover, each of the bridge structures 424 of the touch panel 400 may further include a protection pattern 424c disposed on the conductive pattern 424a. The protection pattern 424c is used to protect the conductive pattern 424a and increase a structural strength of the bridge structure 424 and keep the conductive pattern 424a away from oxidization (the protection pattern 424c does not directly contact the insulation layer 440). A material and a thickness He of the protection pattern 424c can be the same with the material and the film thickness Hc of the protection pattern 124c in FIG. 2A and FIG. 2B, which are not repeated.

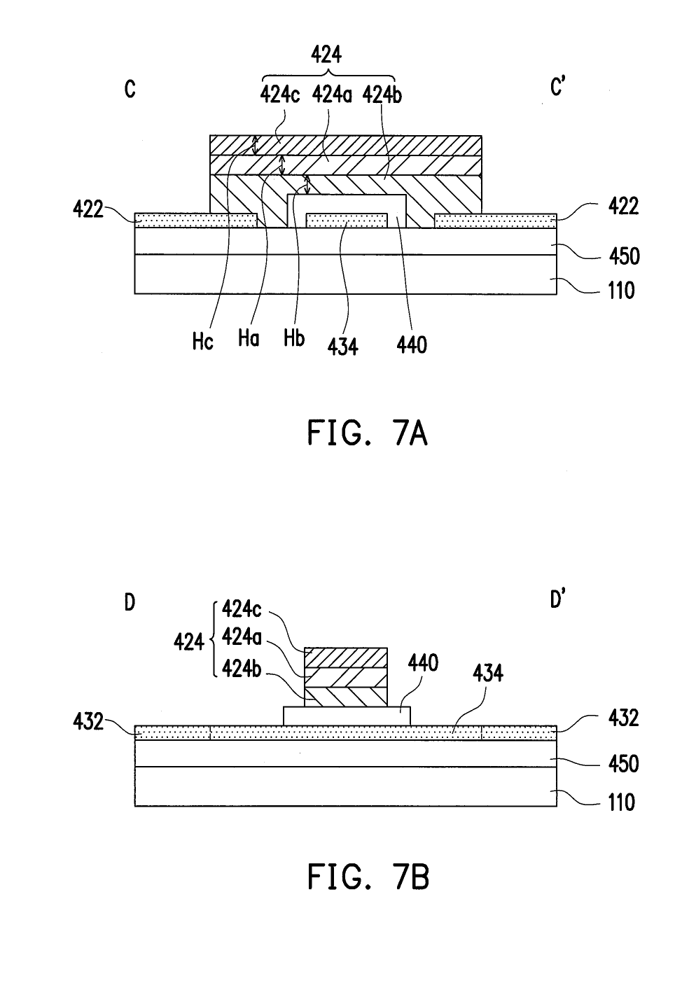

Moreover, as shown in FIG. 7A and FIG. 7B, in another embodiment, the touch panel 400 may further include an extinction layer 450 covering the substrate 110, wherein the extinction layer 450 is disposed between the substrate 110 and the first electrode series 420 and between the substrate 110 and the second electrode series 430. However, in other embodiments, the extinction layer 450 can also cover the first electrode series 420 and the second electrode series 430, so that the first electrode series 420 and the second electrode series 430 are disposed between the extinction layer 450 and the substrate 110.

By configuring the extinction layer 450, a reflectivity difference of the light beam L between a gap G (referring to FIG. 4) between the electrode pads (including the first electrode pads 422 and the second electrode pads 432) and the electrode series (the first electrode series 420 and the second electrode series 430) can be compensated. In this way, visibility of the electrode series to human eyes can be reduced, and thereby the visual effect of the touch panel 400 can be further enhanced.

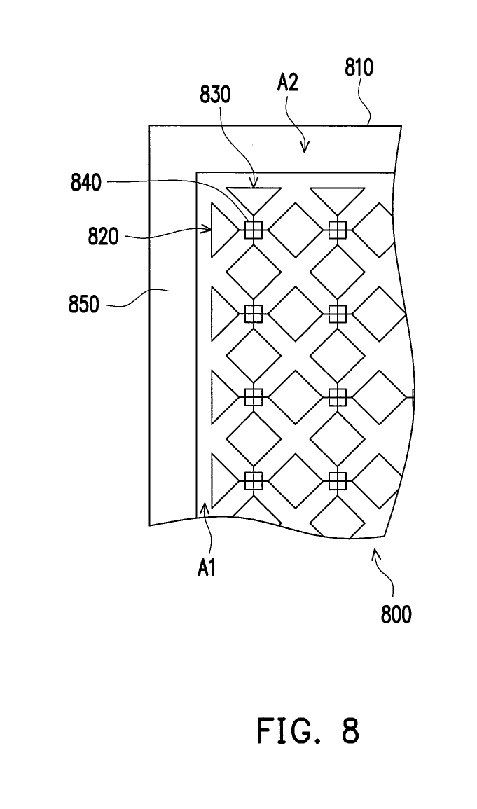

FIG. 8 is a partial top view of a touch panel according to a sixth embodiment of the invention. Referring to FIG. 8, the touch panel 800 of the present embodiment includes a substrate 810, a plurality of first electrode series 820 and a plurality of second electrode series 830, wherein the substrate 810 can be used as a cover lens. Namely, in an actual operation, the first electrode series 820, the second electrode series 830 and an insulation layer 840 are disposed on an inner surface of the substrate 810, and the user touches an outer surface of the substrate 810 in operation. In detail, the substrate 810 has a touch region A1 and a peripheral region A2 located at at least one side of the touch region A1, and the first electrode series 820 and the second electrode series 830 are disposed in the touch region A1. In the present embodiment, the first electrode series 820 and the second electrode series 830 may adopt a configuration relationship of any similar components in the aforementioned first to fifth embodiments, and the touch panel 800 of the present embodiment may further include an insulation layer 840 to electrically insulate the first electrode series 820 and the second electrode series 830. Moreover, the touch panel 800 of the present embodiment may selectively include the aforementioned extinction layer to enhance the visual effect of the touch panel.

A difference between the present embodiment and the aforementioned first to fifth embodiments is that the touch panel 800 of the present embodiment further includes a decoration layer 850, wherein the decoration layer 850 is disposed in the peripheral region A2. In detail, the decoration layer 850 is, for example, used to shield light-shielding devices (not shown) in the peripheral region A2. In other embodiment, touch devices can also be selectively configured in the peripheral region A2 according to an actual requirement.

In the present embodiment, the decoration layer 850 is, for example, disposed on the substrate 810 at a side that same with that of the first electrode series 820 and the second electrode series 830. Namely, the decoration layer 850, the first electrode series 820 and the second electrode series 830 of the present embodiment are disposed on a same surface (the inner surface) of the substrate 810. However, in other embodiments, the decoration layer 850 can also be disposed on the substrate 810 at a side opposite to that of the first electrode series 820 and the second electrode series 830, i.e. the decoration layer 850 can also be disposed on an outer surface (the touch surface) of the substrate 810. Moreover, in other embodiments, the touch panel 800 may further include a carrier board (not shown) disposed on the substrate 810 at a side opposite to that of the first electrode series 820 and the second electrode series 830, i.e. the carrier board is disposed on the outer surface (the touch surface) of the substrate 810, and the decoration layer 850 is, for example, disposed on the carrier board and is disposed between the substrate 810 and the carrier board, wherein an orthogonal projection of the decoration layer 850 on the substrate 810 is within the peripheral region A2 of the substrate 810.

In summary, in the touch panel of the invention, the conductive pattern and the optical matching pattern are used to implement the bridge structures of the electrode series, the optical matching pattern is disposed on the surface of the conductive pattern facing to the user, so as to reduce the reflectivity of the light beam along the viewing direction in areas where the bridge structures are disposed. In this way, a contour of the bridge structures is hardly perceived by the user, and thereby the touch panel may have better visual effect. Moreover, the extinction layer is disposed between the substrate and the first electrode series and between the substrate and the second electrode series, or the first electrode series and the second electrode series are covered by the extinction layer in the present embodiment, though the invention is not limited thereto. Alternatively, a first extinction layer may be configured to cover the first electrode series and the second electrode series, such that the first electrode series and the second electrode series are disposed between the first extinction layer and the substrate, while a second extinction layer may be disposed between the substrate and the first electrode series and between the substrate and the second electrode series so as to reduce the visibility of the electrode series to human eyes can be reduced, and thereby the visual effect of the touch panel can be further enhanced. Moreover, at least one of the first extinction layer and the second extinction layer can be formed by a single layer or a stacked layer of multiple layers.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel, comprising:
a substrate;
a plurality of first electrode series, disposed on the substrate, each of the first electrode series extending along a first direction, and each of the first electrode series comprising a plurality of first electrode pads and a plurality of bridge structures, and each of the bridge structures connecting two adjacent first electrode pads in series along the first direction, wherein each of the bridge structures comprises a conductive pattern and an optical matching pattern, and the optical matching pattern is disposed between a user and the conductive pattern, so as to reduce a reflectivity of a light beam along a viewing direction in areas where the bridge structures are disposed; and
a plurality of second electrode series, electrically insulated to the first electrode series, wherein the second electrode series are disposed on the substrate, and each of the second electrode series extends along a second direction, wherein the first direction is intersected with the second direction, each of the second electrode series comprises a plurality of second electrode pads and a plurality of connection portions, and each of the connection portions connects two adjacent second electrode pads in series along the second direction.

2. The touch panel as claimed in claim 1, further comprising an insulation layer, and the insulation layer is disposed between the first electrode series and the second electrode series.

3. The touch panel as claimed in claim 1, wherein the optical matching pattern is disposed between the conductive pattern and the substrate.

4. The touch panel as claimed in claim 1, wherein a refractive index of the optical matching pattern is within a range of 1.5 to 2.5, and an extinction coefficient of the optical matching pattern is within a range of 0.5 to 2.5.

5. The touch panel as claimed in claim 4, wherein a film thickness of the optical matching pattern of each of the bridge structures is greater than 100 Å and is smaller than 1000 Å.

6. The touch panel as claimed in claim 1, further comprising an insulation layer, the bridge structures, the first electrode pads and the second electrode pads are disposed on the substrate in a coplanar manner, and the bridge structures are disposed between the insulation layer and the substrate, and each of the connection portions is disposed on the insulation layer and crosses over the corresponding bridge structure to electrically connect two adjacent second electrode pads.

7. The touch panel as claimed in claim 1, further comprising an extinction layer, and the first electrode series and the second electrode series are disposed between the extinction layer and the substrate.

8. The touch panel as claimed in claim 1, further comprising an insulation layer, the connection portions, the first electrode pads and the second electrode pads are disposed on the substrate in a coplanar manner, and the connection portions are disposed between the insulation layer and the substrate, such that each of the bridge structures is disposed on the insulation layer and crosses over the corresponding connection portion to electrically connect two adjacent first electrode pads.

9. The touch panel as claimed in claim 1, further comprising an extinction layer disposed on the substrate, and disposed between the substrate and the first electrode series and between the substrate and the second electrode series.

10. The touch panel as claimed in claim 1, wherein a sidewall of the conductive pattern of each of the bridge structures is aligned to a sidewall of the optical matching pattern.

11. The touch panel as claimed in claim 1, wherein a sidewall of the optical matching pattern of each of the bridge structures is covered by the conductive pattern.

12. The touch panel as claimed in claim 1, wherein each of the bridge structures further includes a protection pattern disposed on the conductive pattern, and the conductive pattern is disposed between the protection pattern and the optical matching pattern.

13. The touch panel as claimed in claim 1, wherein the reflectivity of the light beam in an area where the bridge structure is disposed is smaller than 20%.

14. The touch panel as claimed in claim 1, wherein the reflectivity of the light beam in an area where the bridge structure is disposed is smaller than 10%.

15. The touch panel as claimed in claim 1, wherein a material of the conductive pattern of each of the bridge structures comprises gold, silver, copper, aluminium, chromium, platinum, rhodium, molybdenum, titanium, nickel, indium, tin or alloys thereof, or at least one of a nitride, an oxide, an oxynitride of the above metals, or a stacked layer of at least two of the above materials.

16. The touch panel as claimed in claim 1, wherein a material of the optical matching pattern of each of the bridge structures comprises a material the same with that of the conductive pattern.

17. The touch panel as claimed in claim 1, wherein a material of the optical matching pattern of each of the bridge structures comprises a nitride, an oxide or an oxynitride of the material of the conductive pattern.

18. The touch panel as claimed in claim 1, wherein a film thickness of the optical matching pattern of each of the bridge structures is smaller than 1000 Å.

19. The touch panel as claimed in claim 1, wherein each of the first electrode pads is disposed between the optical matching pattern of each of the bridge structures and the substrate.

20. The touch panel as claimed in claim 1, wherein a sidewall of each of the bridge structures is covered and contacted by the corresponding first electrode pads.

21. The touch panel as claimed in claim 1, wherein a film thickness of the conductive pattern of each of the bridge structures is greater than 1000 Å.

22. The touch panel as claimed in claim 1, wherein a light transmittance of the optical matching pattern of each of the bridge structures is greater than a light transmittance of the conductive pattern.

23. The touch panel as claimed in claim 1, wherein a material of the first electrode pads and the second electrode series comprises indium tin oxide, indium zinc oxide, aluminium tin oxide, aluminium zinc oxide, indium zinc germanium oxide, metal grid, or a stacked layer of at least two of the above materials.

24. The touch panel as claimed in claim 1, wherein the first electrode pads and the second electrode series respectively comprise a metal grid layer and an optical matching layer, and the optical matching layer is disposed on a surface of the metal grid layer facing to the user.

25. The touch panel as claimed in claim 1, wherein the substrate has a touch region and a peripheral region located at at least one side of the touch region, and the touch panel further comprises a decoration layer, and the decoration layer is disposed in the peripheral region.

26. The touch panel as claimed in claim 25, wherein the decoration layer is disposed on the substrate at a same side with that of the first electrode series and the second electrode series.

27. The touch panel as claimed in claim 25, wherein the decoration layer is disposed on the substrate at a side opposite to that of the first electrode series and the second electrode series.

28. The touch panel as claimed in claim 25, further comprising a carrier board, wherein the carrier board is disposed on the substrate at a side opposite to that of the first electrode series and the second electrode series, and the decoration layer is disposed on the carrier board and is disposed between the substrate and the carrier board, wherein an orthogonal projection of the decoration layer on the substrate is within the peripheral region.

29. The touch panel as claimed in claim 1, further comprising a first extinction layer and a second extinction layer, wherein the first electrode series and the second electrode series are disposed between the first extinction layer and the substrate, and the second extinction layer disposes on the substrate and is disposed between the substrate and the first electrode series and between the substrate and the second electrode series.

30. The touch panel as claimed in claim 29, wherein the first extinction layer is a single layer or a stacked layer of multiple layers.

31. The touch panel as claimed in claim 29, wherein the second extinction layer is a single layer or a stacked layer of multiple layers.

32. A touch panel, comprising:
a substrate;
a plurality of first electrode series, disposed on the substrate, each of the first electrode series extending along a first direction, and each of the first electrode series comprising a plurality of first electrode pads and a plurality of bridge structures, and each of the bridge structures connecting two adjacent first electrode pads in series along the first direction;
a plurality of second electrode series, electrically insulated to the first electrode series, wherein the second electrode series is disposed on the substrate, and each of the second electrode series extends along a second direction, and the first direction is intersected with the second direction, each of the second electrode series comprises a plurality of second electrode pads and a plurality of connection portions, and each of the connection portions connects two adjacent second electrode pads in series along the second direction;
a first extinction layer, wherein the first electrode series and the second electrode series are disposed between the first extinction layer and the substrate; and
a second extinction layer, disposed on the substrate and being disposed between the substrate and the first electrode series and between the substrate and the second electrode series.

33. The touch panel as claimed in claim 32, wherein the first extinction layer is a single layer or a stacked layer of multiple layers.

34. The touch panel as claimed in claim 32, wherein the second extinction layer is a single layer or a stacked layer of multiple layers.
